(19) United States
(12) Patent Application Publication
(10) Pub. No.: US 2006/0148517 A1
(43) Pub. Date: Jul. 6, 2006

(54) Video conference feature for a mobile communication terminal

(75) Inventor: Jae-Wook Yu, Gyeonggi-Do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/313,869

(22) Filed: Dec. 20, 2005

(30) Foreign Application Priority Data
Dec. 30, 2004 (KR) 10-2004-01173574

(51) Int. Cl. H04N 7/16; H04M 1/00

(52) U.S. Cl. 455/553.1; 725/62

(57) ABSTRACT

A handheld mobile communication device operable in a mobile communication network for communicating multimedia data is provided. In accordance with a preferred embodiment, the mobile communication device comprises a display screen positioned on a first surface of the mobile communication device in a first orientation for viewing by a user; and an orientation adjusting mechanism for allowing a user to change a viewing orientation of the display screen from the first orientation to a second orientation.

### CROSS REFERENCE TO RELATED APPLICATIONS

Pursuant to 35 U.S.C. § 119(a), this application claims the benefit of earlier filing date and right of priority to Korean Patent Application No. 10-2004-0117357, filed on Dec. 30, 2004, the content of which is hereby incorporated by reference herein in its entirety.

### FIELD OF THE INVENTION

The present invention relates to a mobile terminal having video conferencing features and, more particularly, to a mobile terminal having a video conferencing mechanism whereby a display panel 22 can be set to an upright position to provide for a better and more convenient viewing of the displayed content.

### BACKGROUND

FIG. 1 is a perspective view of a slide type mobile terminal in accordance with the related art. The related art mobile terminal includes a main body 110 having a keypad 102 as a user interface. The keypad 102 is mounted on a front surface of the mobile terminal. The mobile terminal also comprises a printed circuit board (PCB) (not shown) on which various circuit components are mounted.

A display unit 120 is slidably mounted on a front side of the main body 110 having an LCD 122 for displaying various information. An antenna 130 is mounted at an upper end of the main body 110 and connected with the PCB to transmit/receive wireless signals including voice and image information.

A battery 104 is mounted at a rear surface of the main body 110. When the display unit 120 is slidably moved to an open position, the keypad 102 mounted at the front surface of the main body 110 is exposed. A microphone 106 for inputting a voice signal is mounted at a lower end of the main body 110.

The display unit 120 includes a speaker 124 formed at its upper portion for outputting sounds and a function key 126 is installed at the lower portion of the display unit. As shown, a first camera 130 for capturing an image is installed on the front surface of the display unit 120 and a second camera (not shown) is installed on the rear surface of the main body 110.

The first camera 130 is required for video conferencing and the second camera is required for taking an image of another person or external environment. The disclosed related art mobile terminal has the following problems.

Since the LCD 122 is disposed in a fixed position on the front surface of the display unit 120, a user must perform video conferencing while looking at the LCD 122 with the mobile terminal held in his hand. This makes the user feel uncomfortable, and when the user uses the mobile terminal for video conferencing for a long time, the hand of the user may shake and cause the images or video displayed to a peer user to be distorted.

In addition, due to the need for the first camera 130 for video conferencing and the second camera for taking videos or images, disadvantageously, the fabrication cost of the mobile terminal increases, the construction of the mobile terminal becomes complicated, and the weight of the mobile terminal increases.

Systems and methods are needed to overcome the aforementioned shortcomings of the related art device.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages, and in accordance with the purpose of the present invention, as embodied and broadly described, the present invention comprises a video conferencing system capable of enhancing user convenience in performing video conferencing and other video related activities, such as sharing and viewing multimedia content.

In a preferred embodiment, the system is configured to minimize the distortion of an image generated when a user performs video conferencing with the mobile terminal held in his hand by using a hinged display panel 22 that can be set to an upright position to allow the user to place the mobile terminal on a desk so that the user can perform video conferencing in a more stable setting.

A mobile terminal, in accordance with one embodiment, comprises a hand-held body for housing electronic components for communication in a mobile communications network; and a display panel rotatably mounted on the body so that the display panel is configured to move away from and towards the body by rotating about one or more hinges connecting the display panel to the body.

The method of claim 1 further comprises a camera coupled to the body, wherein a receiving cavity is formed on a front face of the body for receiving the display panel. The mobile terminal may further comprise a hinge connection mechanism comprising one or more hinges for rotatably connecting the edge of the display panel to the body; and at least a hinge pin to engage the one or more hinges in a rotational relationship with the body.

The hinge connection mechanism is constructed to engage the hinge pin and the one or more hinges in a tight friction loaded configuration so that the display panel can rotate about a first axis of the hinge pin in a smooth continuous path of travel. A locking mechanism may be also included for firmly securing the display panel in the receiving cavity in a closed position.

In one embodiment, the locking mechanism comprises a locking rod comprising first and second opposite ends, wherein the first end is configured to removably engage a locking recess formed at one edge of the display panel to maintain the display panel in a locked position within the receiving cavity; an operation lever connected to the locking rod and accessible by a user to manipulate the locking rod in first and second directions for respectively engaging and disengaging the locking recess.

The locking mechanism further comprises a biasing member installed at the second end of the locking rod to provide a reflecting force against the movement of the locking rod in the second direction. The mobile terminal of claim 2, wherein the camera is rotatably installed in the body such that the camera can be rotated to point toward front and rear of the body 10.

A first aperture may be formed at the front surface of the body and a second aperture at the rear surface of the body, wherein the camera can be rotated to face each of the first and second apertures based on user's preference for capturing images in respectively first and second directions.

In a preferred embodiment, a handheld mobile terminal for communicating in a mobile communication network comprises a first body having top and bottom surfaces and a keypad mounted on a top surface of the first body; a second body having top and bottom surfaces, wherein the top surface of the first body faces the bottom surface of the second body in a closed position, thereby hiding the keypad there between; a sliding mechanism in an operational relationship with the first and second bodies for allowing the second body to slide over the first body to expose the keypad in an open position; a display panel mounted in a recessed surface of the second body, wherein in a closed position the display panel is configured to lay parallel to the recessed surface and in an open position the display panel is rotated about a hinge to at least partially move away from the recessed surface.

A camera may be installed on the second body and the recessed surface may be formed on the top surface of the second body. A hinge connection mechanism for the mobile terminal comprises one or more hinges for rotatably connecting an edge of the display panel to the top surface of the second body; and at least a hinge pin to engage the one or more hinges in a rotational relationship with the top surface of the second body.

The hinge connection mechanism is constructed to engage the hinge pin and the one or more hinges in a tight friction loaded configuration so that the display panel can rotate about a first axis of the hinge pin in a smooth continuous path of travel.

The mobile terminal may also comprise a locking mechanism for firmly securing the display panel in the recessed surface in a closed position, wherein the locking mechanism comprises a locking rod comprising first and second opposite ends, wherein the first end is configured to removably engage a locking recess formed at one edge of the display panel to maintain the display panel in a locked position within the recessed surface; an operation lever connected to the locking rod and accessible by a user to manipulate the locking rod in first and second directions for respectively engaging and disengaging the locking recess.

The locking mechanism further comprises a biasing member installed at the second end of the locking rod to provide a reflecting force against the movement of the locking rod in the second direction. The camera is rotatably installed in the second body such that the camera can be rotated to point toward front and rear of the mobile terminal.

A first aperture is formed at the front surface of the second body and a second aperture is formed at the rear surface of the second body, wherein the camera can be rotated to face each of the first and second apertures based on user's preference for capturing images in respectively first and second directions.

In accordance with yet another embodiment, a handheld mobile terminal for communicating in a mobile communication network comprises a body with an upper portion and a lower portion that slide relative to each other; a display screen located on the body and being flush therewith, while in a first operation mode a user views the display screen in a first viewing angle; and a hinge mechanism located along one edge of the display screen, allowing the display screen to be inclined at an angle with respect to the body while in a second operation mode, the user views the display screen in a second viewing angle.

An image capture device may be connected with the body and capable of being adjusted to point towards the user who views the display screen in at least one of the first viewing angle and the second viewing angle. The second operation mode can be used for video conferencing purposes. Preferable, the display screen has a top edge, a bottom edge, a left edge and a right edge, and the hinge mechanism is located at the top edge.

In another preferred embodiment, a handheld mobile communication device is operable in a mobile communication network for communicating multimedia data. The mobile communication device comprises a display screen positioned on a first outer surface of the mobile communication device and facing outwardly in a first orientation for viewing by a user; a camera module rotatably disposed in the first outer surface of the mobile communication device and facing outwardly in a second orientation for capturing an image; and an orientation adjusting mechanism configured to allow changing the first orientation of the display screen to a third orientation.

A portion of the display screen is coupled to the first outer surface of the mobile communication device, and a distal end of the display screen can move away from the first outer surface of the mobile communication device. The orientation adjusting mechanism is further configure to allow changing the second orientation of the camera module to a fourth orientation, such that tilting angle of the display screen and rotating angle of the camera module are separately adjustable.

In the first orientation the display screen is positioned parallel to the first surface of the mobile communication device, for example. In the second orientation the display screen is positioned to form a first angle with the first surface of the mobile communication device by rotating around a first axis.

A lock mechanism may be use to limit the movement of the display screen in the first orientation. The orientation adjusting mechanism comprises a first hinge structure for providing a non-locking but tight fitting engagement to rotatably connect the display screen and the first surface of the mobile terminal, so that the display screen may freely rotate about a first axis of the first hinge structure from a first position to a second position.

In some embodiments, the orientation adjusting mechanism further comprises a second hinge structure for allowing the display screen to revolve about a second axis approximately perpendicular to the first axis. The orientation adjusting mechanism may also comprise a third hinge structure for allowing the camera lens to rotate about a third axis.

In a preferred embodiment, the display screen is positioned between the camera lens and an interface mechanism of the handheld mobile communication device. A content adjusting mechanism may be used for adjusting a display orientation of content on the display screen based on at least one of the third and fourth orientations. The content adjusting mechanism updates the display orientation of the content when orientation of the display screen is changed to the third orientation.

The orientation adjusting mechanism comprises a first adjusting mechanism for adjusting the display screen and a second adjusting mechanism for adjusting the camera lens, the first and second adjusting mechanisms operating independent from one another.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view of a slide type mobile terminal in accordance with the related art.

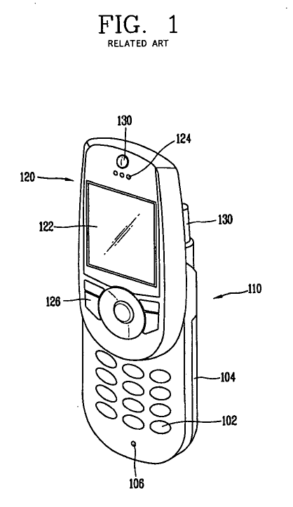

FIG. 2 is a perspective view of a mobile terminal having a video conferencing system in accordance with a preferred embodiment.

FIG. 3 is a sectional view of the mobile terminal of FIG. 2 having the video conferencing system in accordance with another embodiment.

FIG. 4 is a perspective showing an operation state of the mobile terminal having the video conferencing system in accordance with yet another embodiment.

Features, elements and aspects of the invention that are referenced by the same numerals in different figures represent the same, equivalent, or similar features, elements, or aspects in accordance with one or more embodiments of the system.

### DETAILED DESCRIPTION OF THE PREFERRED EMBODIMENTS

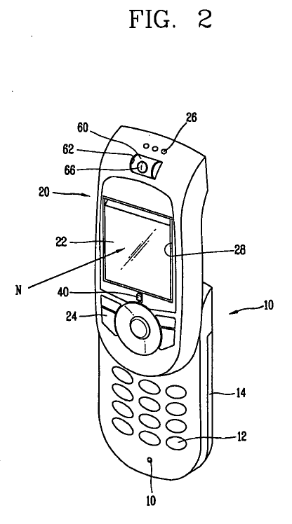

Referring to FIG. 2, an exemplary embodiment of a mobile terminal in accordance with one aspect of the invention comprises a first body 10 having a keypad 12 provided on front surface of the first body 10 for allowing a user to input information. As shown, a second body 20 is provided that, for example, slides in a first direction and preferably longitudinally over the first body 10 to expose the keypad 12 on the front surface of the first body 10.

As provided in further detail below, one or more embodiments of the invention are disclosed as applicable to a sliding-type mobile terminal. This is, however, by way of example and the features and principals disclosed herein are applicable to any type of mobile terminal, such as a candy-bar design, a clamshell design, or other structural design used to manufacture a mobile terminal.

In a preferred embodiment, the display pane 22 is rotatably mounted in a first position on the front surface of the first body 10 for displaying various information. In addition, instead or in conjunction with the rotatable feature disclosed above, alternative embodiments may be configured to allow the display pane 22 to tilt, slide out, pop out, unfold, pivot, swivel, revolve or otherwise move away from the first position on the front surface of the first body 10.

A battery 14 can be mounted at a rear surface of the first body 10 or second body 20. When the second body 20 is slidably moved to an open position, the keypad 12 mounted on the front surface of the first body 10 is exposed. A microphone 16 for inputting a voice signal is mounted, for example, at one end of the first body 10 or second body 20.

In one embodiment, the second body 20 comprises a function key 24 (e.g., a user interface mechanism). A speaker 26 may be also included, for example, at an upper portion of the front side of the second body 20. In one embodiment, a second microphone (not shown) may be also provided near the speaker 26.

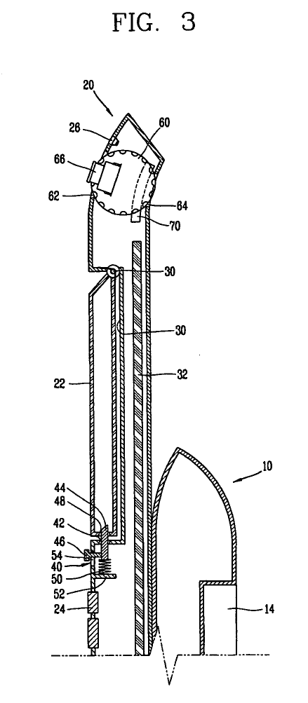

Referring to FIGS. 2 and 3, a PCB 32 having a plurality of circuit components is housed inside the second body 20. A receiving cavity 28 is formed on the a front surface of the second body 20. The cavity is configured to receive the display panel 22 having a distal end and a proximal end.

In another embodiment, a hinge connection part 30 may be used for rotatably coupling the proximal end of the display panel 22 in the receiving cavity 28. Preferably, the hinge connection part 30 is a pin-style hinge with a pin sliding into one or more cylindrically shaped hinges, for example, formed at the proximal end of the display panel 22.

The hinge connection part 30 is configured to allow display panel 22 to rotate about a first axis disposed approximately near one end of the receiving cavity in a tight friction loaded relationship with one or more hinges, so that the display panel 22 can rotate about the hinge pin to form a first angle with the second body 20 when in an open position.

Depending on implementation, the first axis may be disposed along any portion of the display panel 22 and the movement of the display panel 20 may be controlled to limit the rotation angle about the hinge pin to a maximum of approximately 90 degrees, for example. In other implementations, the rotation angle may not be limited so that the display panel 22 can be rotated to form an acute or obtuse angle with the second body 20.

In an exemplary embodiment, when in an open position, the display panel 22 can be rotated about the first axis in a controlled manner to stop at fixed rotation points. The fixed rotation points are selected to allow the display panel 22 form successive predetermined angles with the second body 20 in, for example, a lock-step relationship.

In yet another embodiment, instead of implementing a lock-step relationship, a smooth continuous path of travel is implemented. As such, the display panel 22 can be freely rotated by the user to stop at any desirable viewing angle. This feature may be implemented as suggested earlier by constructing a tight friction loaded relationship between the inner surfaces of the one or more hinges and the hinge pin. Other implementations, using spring-loaded structures or biasing members to control the movement of the display panel 22 are of possible use in alternative embodiments.

Referring to more specifically to FIG. 3, a locking unit 40 can be installed in the second body 20 in order to lock the distal end of the display panel 22 (i.e., the end opposite the hinge) when the display panel 22 is disposed in the receiving cavity 28 in a closed position. The locking unit 40, in one embodiment, comprises a locking rod 44 having a first end protruding from an aperture 42 formed at an inner area of the receiving cavity 28, for example.

The first end of the locking rod is configured to removably engage a locking recess 48 formed at the distal end of the display panel 22, when the display panel is in the closed position. Accordingly, in a closed position, the locking recess 48 and the aperture 42 are approximately aligned to allow for the first end of locking rod 44 engage the locking recess 48.

The locking rod 44 is mounted in the second body 20 and engaged with an operation lever 46 exposed out of a guide groove 54 formed in one side of the second body 20. A user can operate the locking rod 44 to be moved in first and second directions (e.g., downwardly or upwardly) to respectively disengage or engage the locking recess 48 formed at the distal end of the display panel 22.

In a preferred embodiment, the locking rod 44 is spring loaded. For example, a spring 50 can be installed between a second end of the locking rod 44 and a spring sheet 52. The second end is positioned opposite to the first end of the locking rod 44 that engages the locking recess 48. The spring sheet 52 is a fixed platform, for example, formed at an inner surface of the second body 20, as shown.

Spring 50 provides a biasing force to propel the locking rod 44 in a first direction toward the locking recess 48. The spring sheet 52 supports the spring 50 and prevents the locking rod 44 from moving beyond a predetermined point in a second direction, opposite the first direction.

In one embodiment, the display panel 20 is disposed in the receiving cavity 28, in a closed position, the first end of the locking rod 44 engages the locking recess 48, thus maintaining the display panel 20 in the receiving cavity 28. When the user manipulates the operation lever 46 (e.g., by way of exerting force, touching, pressing, pulling, etc.), the locking rod 44 is moved in the second direction toward the spring sheet 52 and overcomes the biasing force of the spring 50. As a result, the first end of locking rod 44 is released from the locking recess 48 to place the display panel 22 in an unlocked state.

The camera 60 can be rotatably installed at one end and preferably at the upper end of the second body 20. A first camera mounting aperture 62 exposing a camera lens 66 toward the front of the second body 20 can be formed at the upper portion of the front surface of the second body 20. A second camera mounting aperture 64 exposing the camera lens 66 towards the rear of the second body 20 can be formed at the rear surface of the second body 20.

Accordingly, the camera 60 can be rotatably mounted on the second body 20, so that when the camera lens 66 (or the camera module) is positioned towards the first camera mounting aperture 62, the camera 60 can be used for video conferencing, for example. When the camera lens 66 is positioned towards the second camera mounting aperture 64, the camera 60 can be used for capturing images and videos, for example. In this manner, the single camera 60 can be rotatably mounted at the second body 20 and capture images and videos and also for video conferencing.

An antenna 70 can be internally or externally installed, for example, at one end of the second body 20. Preferably, an internal antenna 70 may be used. In one embodiment, an internal antenna 70 is configured to adapt to or complement a curved inner surface of the second body 20 and so that it does not obstruct the camera lens 66 when the camera rotates toward the second camera mounting aperture 64.

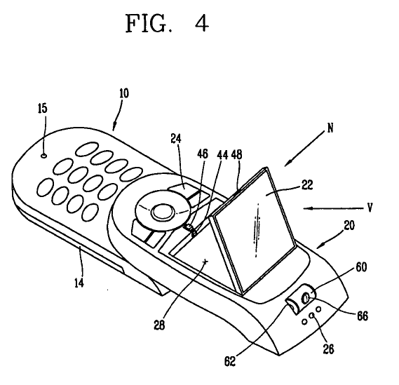

Referring to FIG. 4, an operational state of the mobile terminal having the video conferencing system in accordance with one embodiment is provided.

When the mobile terminal is used to capture images and video, the display panel 22 can be set in the receiving cavity 28 of the second body 20 in a closed position or locked state if the locking unit 50 is engaged, as provided above. The camera 60 can be rotated to face the second camera mounting aperture 64 formed at the rear surface of the second body 20. In this state, the user can capture images and video while looking at the display panel 22.

When the mobile terminal is used to perform video conferencing, the camera 60 can be rotated to face the first camera mounting aperture 62 formed at the front surface of the second body 20. In one embodiment, the operation lever 46 may be pulled out or otherwise manipulated to release the locking rod 44 from the locking recess 48 in order to unlock the display panel 22. In this state, the display panel 22 may be rotated out from the receiving unit to be set to an upright position, for example, or any other suitable viewing angle.

As provided earlier, in one embodiment, the hinge connection part 30 has a lock-free friction tight construction, so that the user can adjust the display panel 22 to a desired viewing angles. Thus, when the mobile terminal is placed on a desk or other surface, the user can perform video conferencing by adjusting the viewing angle for the display panel 22.

As shown in FIG. 4, the numeral reference “V” denotes a general viewing direction (i.e., line of sight) of the user during video conferencing. For example, if the user wishes to perform a video teleconference with another party located elsewhere, the display panel 22 may be set to an upright position, and the mobile terminal itself may be placed on a desk such that the user can look at the display panel 22 from a first direction “V” to view images of the another party.

The mobile terminal camera is configured to capture images of the user so that it can be sent to another party for viewing. It should be noted that the angle of the display panel 22 may be adjusted according to the user's preference.

The feature of adjusting the display panel 22 to an upright position can be expressed in different terms. Namely, it can be said that the display panel 22 may be flipped open or closed. In other words, the display panel 22 may be folded up (to an upright state) or folded down (to a flat state). Likewise, the display panel 22 can be described as a “flap” that can be opened to various viewing angles used for viewing during video conferencing, and closed to its flat normal position.

Other possible embodiments to achieve the desired viewing angle for the display panel 22 may be implemented. In a first preferred embodiment, the display panel 22 can be flipped open or closed about a hinge (or other rotating means) at its top edge. In a second preferred embodiment, the display panel 22 may be flipped open or closed about a hinge at its bottom edge, for example.

Such embodiments may be advantageous because the need for graphics processing to “flip” the images to be displayed may not be required. This would be possible if the display panel 22 having a hinge at its bottom edge additionally has another pivot point at the bottom edge to allow the display panel 22 to pivot, revolve or swivel around (e.g., 180 degrees).

The second embodiment may advantageously comprise a pivot point (not shown) about which the display panel 22 may pivot, revolve or swivel. Thus, in addition to the hinge that provides for the distal end of display panel 22 to rotate about the axis of the hinge toward and away from the mobile terminal, the pivot point allows the display panel 22 to panoramically revolve about a second axis, wherein the second axis is approximately perpendicular to the axis of the hinge pin. Accordingly, in one embodiment, the display panel 22 can freely pivot 360 degrees so that a viewer can view the screen from any angle.

In one embodiment, the locking unit 40 is located at a different position than that of the locking unit 40 shown in FIG. 4, to provide room for the pivot point. In another embodiment, the display panel 22 may be configure with a hinge constructed along a longitudinal direction. To do so, the camera unit can rotate or adjust to capture the images of the user who views the display panel 22 being flipped open the respective side.

When the display panel 22 is adjusted to an upright position, the orientation of the images (e.g., video, graphics, visual information, etc.), may need to be changed. For example, when the user views the display panel 22 from a direction V (shown as arrow “V” in FIG. 4), the images shown on the display panel 22 may need to be “flipped” or “rotated”. Otherwise, when the display panel 22 is in an upright position, an “upside-down” image would appear when viewed from direction V.

In accordance with one aspect of the invention, the rotation angle of the single camera in the mobile terminal is detected. During ordinary phone usage, the camera points in a first direction towards to user. For video conferencing, the camera can be rotated around or laid on its side, such that it points in a second direction toward a user looking at the display unit in the upright position. Depending on such rotation angles of the camera itself, the graphics image processor may provide the appropriate orientation of the images being displayed upon detecting the current camera rotation angle being used.

Alternatively, the image orientation adjustment can be achieved by using appropriate graphics processing regardless of the camera angle. For example, the camera function may be turned off such that an image of the user himself is not transmitted to the other party, yet the user can view images of the other party on his display panel 22 in the upright position. Here, a graphics image processor within the mobile terminal can cooperate with the mechanisms used to adjust the display panel 22 position, such that when the display panel 22 is flipped to an upright position and video conferencing or other image display functions are to be performed, the graphics image processor may appropriately adjust the orientation of the images to be displayed upon the detection of the upright position of the display panel 22.

In FIG. 4, the camera is of the type that can rotate around an axis that is parallel to the hinge axis of the display panel 22. In a preferred embodiment, the camera is located above the top edge of the display panel 22 with respect to a slide type mobile terminal viewed in the normal direction (e.g., represented by arrow “N”). However, the camera may be mounted or attached to other locations on the handset in accordance with other embodiments.

Other types of camera direction adjustments are possible. For example, if the hinge is longitudinally located along one of the side edges of the display panel 22, the camera may pivot on an axis that is parallel with the side edges of the display panel 22 in its flat position. Other pivot mechanisms may allow the camera to point in various three-dimensional directions without being limited to rotations on the x-axis or y-axis (i.e., horizontal or vertical rotations). Thus, various solutions to adjusting the image orientation can be implemented, depending on one or more factors associated with the position of the display panel 22, the user's line of sight and the camera angle.

The mobile terminal having the video conferencing system in accordance with the present invention has many advantages. For example, since the viewing angle of the display panel 22 is adjustable, the user can put the mobile terminal on a desk for video conferencing. This will improve picture clarity as it provides a more stable environment for the mobile terminal. In addition, the camera can be easily rotated and positioned to point toward either the front or rear of the mobile terminal. Accordingly, video conferencing and video recording can be performed by using a single camera. This will advantageously reduce the fabrication cost and the weight of the mobile terminal.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A mobile terminal comprising:
a hand-held body for housing electronic components for communication in a mobile communications network; and
a display panel rotatably mounted on the body so that the display panel is configured to move away from and towards the body by rotating about one or more hinges directly connecting the display panel to the body.

2. The method of claim 1 further comprising a camera coupled to the body.

3. The mobile terminal of claim 1, wherein a receiving cavity is formed on a front face of the body for receiving the display panel.

4. The mobile terminal of claim 1, further comprising a hinge connection mechanism comprising:
said one or more hinges for rotatably connecting the edge of the display panel to the body; and
at least a hinge pin to engage the one or more hinges in a rotational relationship with the body.

5. The mobile terminal of claim 4, wherein the hinge connection mechanism is constructed to engage the hinge pin and the one or more hinges in a tight friction loaded configuration so that the display panel can rotate about a first axis of the hinge pin in a smooth continuous path of travel.

6. The mobile terminal of claim 1, further comprising:
a locking mechanism for firmly securing the display panel in the receiving cavity in a closed position.

7. The mobile terminal of claim 6, wherein the locking mechanism comprises:
a locking rod comprising first and second opposite ends, wherein the first end is configured to removably engage a locking recess formed at one edge of the display panel to maintain the display panel in a locked position within the receiving cavity;
an operation lever connected to the locking rod and accessible by a user to manipulate the locking rod in first and second directions for respectively engaging and disengaging the locking recess.

8. The mobile terminal of claim 7, wherein the locking mechanism further comprises:
a biasing member installed at the second end of the locking rod to provide a reflecting force against the movement of the locking rod in the second direction.

9. The mobile terminal of claim 2, wherein the camera is rotatably installed in the body such that the camera can be rotated to point toward front and rear of the body.

10. The mobile terminal of claim 9, wherein a first aperture is formed at the front surface of the body and a second aperture is formed at the rear surface of the body, wherein the camera can be rotated to face each of the first and second apertures based on user's preference for capturing images in respectively first and second directions.

11. A handheld mobile terminal for communicating in a mobile communication network, the mobile terminal comprising:
a first body having top and bottom surfaces and a keypad mounted on a top surface of the first body;
a second body having top and bottom surfaces, wherein the top surface of the first body faces the bottom surface of the second body in a closed position, thereby hiding the keypad there between;
a sliding mechanism in an operational relationship with the first and second bodies for allowing the second body to slide over the first body to expose the keypad in an open position;
a display panel mounted in a recessed surface of the second body, wherein in a closed position the display panel is configured to lay parallel to the recessed surface and in an open position the display panel is rotated about a hinge to at least partially move away from the recessed surface.

12. The mobile terminal of claim 11, further comprising a camera installed on the second body.

13. The mobile terminal of claim 11, wherein the recessed surface is formed on the top surface of the second body.

14. The mobile terminal of claim 11, further comprising a hinge connection mechanism comprising:
one or more hinges for rotatably connecting an edge of the display panel to the top surface of the second body; and
at least a hinge pin to engage the one or more hinges in a rotational relationship with the top surface of the second body.

15. The mobile terminal of claim 14, wherein the hinge connection mechanism is constructed to engage the hinge pin and the one or more hinges in a tight friction loaded configuration so that the display panel can rotate about a first axis of the hinge pin in a smooth continuous path of travel.

16. The mobile terminal of claim 11, further comprising:
a locking mechanism for firmly securing the display panel in the recessed surface in a closed position.

17. The mobile terminal of claim 16, wherein the locking mechanism comprises:
a locking rod comprising first and second opposite ends, wherein the first end is configured to removably engage a locking recess formed at one edge of the display panel to maintain the display panel in a locked position within the recessed surface;
an operation lever connected to the locking rod and accessible by a user to manipulate the locking rod in first and second directions for respectively engaging and disengaging the locking recess.

18. The mobile terminal of claim 17, wherein the locking mechanism further comprises:
a biasing member installed at the second end of the locking rod to provide a reflecting force against the movement of the locking rod in the second direction.

19. The mobile terminal of claim 12, wherein the camera is rotatably installed in the second body such that the camera can be rotated to point toward front and rear of the mobile terminal.

20. The mobile terminal of claim 19, wherein a first aperture is formed at the front surface of the second body and a second aperture is formed at the rear surface of the second body, wherein the camera can be rotated to face each of the first and second apertures based on user's preference for capturing images in respectively first and second directions.

21. A handheld mobile terminal for communicating in a mobile communication network, the mobile terminal comprising:
a body with an upper portion and a lower portion that slide relative to each other;
a display screen located on the body and being flush therewith, while in a first operation mode a user views the display screen in a first viewing angle; and
a hinge mechanism located along one edge of the display screen, allowing the display screen to be inclined at an angle with respect to the body while in a second operation mode, the user views the display screen in a second viewing angle.

22. The mobile terminal of claim 21, further comprising:
an image capture device connected with the body and capable of being adjusted to point towards the user who views the display screen in at least one of the first viewing angle and the second viewing angle.

23. The mobile terminal of claim 21, wherein the second operation mode can be used for video conferencing purposes.

24. The mobile terminal of claim 21, wherein the display screen has a top edge, a bottom edge, a left edge and a right edge, and the hinge mechanism is located at the top edge.

25. A handheld mobile communication device operable in a mobile communication network for communicating multimedia data, the mobile communication device comprising:
a display screen positioned on a first outer surface of the mobile communication device and facing outwardly in a first orientation for viewing by a user;
a camera module rotatably disposed in the first outer surface of the mobile communication device and facing outwardly in a second orientation for capturing an image; and
an orientation adjusting mechanism configured to allow changing the first orientation of the display screen to a third orientation, such that a portion of the display screen is coupled to the first outer surface of the mobile communication device, and a distal end of the display screen can move away from the first outer surface of the mobile communication device,
wherein the orientation adjusting mechanism is further configure to allow changing the second orientation of the camera module to a fourth orientation, such that tilting angle of the display screen and rotating angle of the camera module are separately adjustable.

26. The handheld mobile communication device of claim 25, wherein in the first orientation the display screen is positioned parallel to the first surface of the mobile communication device.

27. The handheld mobile communication device of claim 25, wherein in the second orientation the display screen is positioned to form a first angle with the first surface of the mobile communication device by rotating around a first axis.

28. The handheld mobile communication device of claim 25, further comprising a lock mechanism for limiting movement of the display screen in the first orientation.

29. The handheld mobile communication device of claim 25, wherein the orientation adjusting mechanism comprises a first hinge structure for providing a non-locking but tight fitting engagement to rotatably connect the display screen and the first surface of the mobile terminal, so that the display screen may freely rotate about a first axis of the first hinge structure from a first position to a second position.

30. The handheld mobile communication device of claim 29, wherein the orientation adjusting mechanism further comprises a second hinge structure for allowing the display screen to revolve about a second axis approximately perpendicular to the first axis.

31. The handheld mobile communication device of claim 25, wherein the orientation adjusting mechanism comprises a third hinge structure for allowing the camera lens to rotate about a third axis.

32. The handheld mobile communication device of claim 25, wherein the display screen is positioned between the camera lens and an interface mechanism of the handheld mobile communication device.

33. The handheld mobile communication device of claim 25 further comprising:
a content adjusting mechanism for adjusting a display orientation of content on the display screen based on at least one of the third and fourth orientations.

34. The handheld mobile communication device of claim 33, wherein the content adjusting mechanism updates the display orientation of the content when orientation of the display screen is changed to the third orientation.

35. The handheld mobile communication device of claim 25, wherein the orientation adjusting mechanism comprises a first adjusting mechanism for adjusting the display screen and a second adjusting mechanism for adjusting the camera lens, the first and second adjusting mechanisms operating independent from one another.
